(19) United States
(12) Patent Application Publication
(10) Pub. No.: US 2016/0373443 A1
(43) Pub. Date: Dec. 22, 2016

(54) DECRYPTION CIRCUIT, COMMUNICATIONS APPARATUS, AND COMMUNICATIONS SYSTEM

(71) Applicants: Hitoshi NAMIKI, Kanagawa (JP); Naoya MORITA, Kanagawa (JP)

(72) Inventors: Hitoshi NAMIKI, Kanagawa (JP); Naoya MORITA, Kanagawa (JP)

(73) Assignee: Ricoh Company, Ltd., Tokyo (JP)

(21) Appl. No.: 15/184,180

(22) Filed: Jun. 16, 2016

(30) Foreign Application Priority Data
Jun. 18, 2015 (JP) 2015-122844

(51) Int. Cl. H04L 29/06

(52) U.S. Cl. CPC H04L 63/0876; H04L 63/0464; H04L 63/0869

(57) ABSTRACT

A decryption circuit includes a decryption circuitry configured to decrypt encrypted data in each encrypted unit block to acquire a decryption result, and an authentication circuitry configured to authenticate the encrypted data, using the decryption results, in parallel with decrypting the encrypted data in each encrypted unit block by the decryption circuitry until the decryption results amount to a first size of the encrypted data. The encrypted data has a first area and a second area, the first area and the second area are added to calculate the first size of the encrypted data. The first area of the encrypted data is definitely included in a field of the encrypted data to be used for authentication, and the second area of the encrypted data possibly includes data of the field of the encrypted data to be used for authentication.

### CROSS-REFERENCE TO APPLICATIONS

The present patent application is based on and claims the benefit of priority of Japanese Priority Application No. 2015-122844, filed on Jun. 18, 2015, the entire contents of which are hereby incorporated herein by reference.

### BACKGROUND

1. Technical Field

The present disclosure relates to decryption circuits, communications apparatuses using the decryption circuits, and communications systems using the communications apparatuses.

2. Description of the Related Art

Various apparatuses are connected to a network, and even miniaturized and less power consuming apparatuses are required to carry out high security communications. According to “IoT” (Internet of Things), various things such as home electrical appliances, automobiles, and so forth, are connected to the Internet or the cloud, and exchange information so as to control each other. For example, sensors are installed in traffic lights or traffic signs on roadside to detect vehicles, and a traffic volume per unit time is sent to vehicles or portable terminals such as smart phones via the cloud so that a traffic jam can be avoided.

However, if such information from a traffic light may be spoofed, a malicious user may intentionally cause a traffic jam. In order to avoid such a situation, communications contents may be authenticated or encrypted. However, if communications contents are authenticated or encrypted, the communications rate may be degraded, and it may be difficult to satisfy a demand for real-time information. Also, a process of encrypting and decrypting communications contents may require a lot of process cost for a CPU (Central Processing Unit). For example, in a miniaturized apparatus, there may occur not only degradation in the communications rate but also an interruption of another process because a CPU is occupied in carrying out a process of encrypting and decrypting communications contents.

Studies are being made to improve the communications rate while avoiding a CPU from being occupied by a process of encrypting and decrypting communications contents through hardware implementation of a communications protocol such as TLS (Transport Layer Security) or IPsec using hardware. In particular, technology has been proposed to carry out a decryption process and an authentication process according to TSL in parallel to improve the process speed (for example, see Japanese Unexamined Patent Application Publication No. 2013-009276).

### SUMMARY

According to one aspect, a decryption circuit includes a decryption circuitry configured to decrypt encrypted data in each encrypted unit block to acquire a decryption result, and an authentication circuitry configured to authenticate the encrypted data, using the decryption results, in parallel with decrypting the encrypted data in each encrypted unit block by the decryption circuitry until the decryption results amount to a first size of the encrypted data. The encrypted data has a first area and a second area, the first area and the second area are added to calculate the first size of the encrypted data. The first area of the encrypted data is definitely included in a field of the encrypted data to be used for authentication, and the second area of the encrypted data possibly includes data of the field of the encrypted data to be used for authentication.

Other objects, features, and advantages will become more apparent from the following detailed description when read in conjunction with the accompanying drawings.

### BRIEF DESCRIPTION OF THE DRAWINGS

FIG. 1 is a general configuration diagram of a communications system;

FIG. 2 illustrates a packet configuration according to TLS;

FIG. 3 is a diagram illustrating input data for authentication according to TLS;

FIG. 4 is a diagram illustrating a data length of data allowed to be input to an authentication process;

FIG. 5 is a diagram illustrating a feature of a decryption circuit, and a data length of data allowed to be input to an authentication process in the decryption circuit;

FIG. 6 is a general configuration diagram of the decryption circuit;

FIG. 7 is a configuration example of a HASH process unit of an authentication process unit;

FIG. 8 is another configuration example of the HASH process unit of the authentication process unit;

FIGS. 9A and 9B illustrate a process flow of the decryption circuit;

FIG. 10 is a general configuration diagram of another configuration of the decryption circuit; and

FIG. 11 illustrates an application example of a communications system.

### DETAILED DESCRIPTION OF EMBODIMENTS

When decryption and authentication are carried out in parallel using a hardware circuit, it may be difficult to carry out decryption and authentication in parallel on or near an end of a packet. This is because information concerning a padding length is placed at the end of a packet, and the contents to be input to an authentication process is not determined until the padding length is determined as a result of the end of the packet being decrypted. If the padding length is assumed to have its maximum value, i.e., 255 bytes, a decryption process and an authentication process are not carried out in parallel on or near the end of the packet. In particular, data that has a smaller packet size has little data portion on which decryption and authentication can be carried out in parallel, and actually no advantageous effect concerning carrying out decryption and authentication in parallel may be conferred.

An object of the present disclosure is to provide a decryption circuit to increase the process speed of decrypting and authenticating data having various packet sizes, a communications apparatus that uses the decryption circuit, and a communications system that uses the communications apparatus.

According to the present disclosure, it is assumed that the padding length of a packet is less than or equal to the size of each encrypted unit block (i.e., 16 bytes or less, for example), and authentication on given data is started before the padding length is determined as a result of the corresponding field being decrypted. Thereby, areas, on which decryption and authentication can be carried out in parallel, of packets can be increased for the packets of various sizes.

As a result, it is possible to increase the speed of the decryption process and the authentication process on data of various packet lengths.

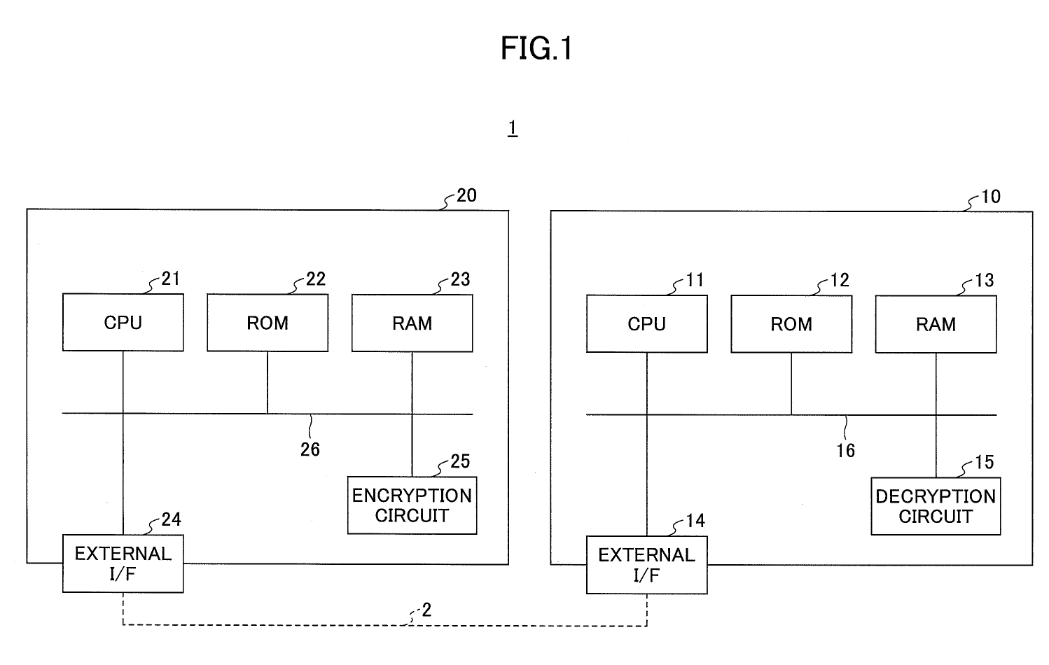

Below, referring to the drawings, decryption circuits, communications apparatuses, and communications systems will be described. FIG. 1 is a general configuration diagram of a communications system. The communications system 1 includes a communications apparatus 10 and a communications apparatus 20 mutually connected via a transmission channel 2. The communications apparatus 20 is a transmitter having, for example, an encryption function. The communications apparatus 10 is a receiver having a decryption function. The transmission channel 2 may be a wired transmission line such as a coaxial cable, an optical fiber cable, a wireless channel, or a USB (Universal Serial Bus). The communications apparatus 10 and the communications apparatus 20 may be mutually connected via any network such as the Internet, the cloud, or a LAN (Local Area Network).

The communications apparatus 20 includes a CPU 21, a ROM (Read-Only Memory) 22, a RAM (Random Access Memory) 23, an external interface (I/F) 24, and an encryption circuit 25, mutually connected via a bus 26. The encryption circuit 25 encrypts transmission data using, for example, a TLS protocol. The encryption circuit 25 uses, for example, the AES (Advanced Encryption Standard) as a common key encryption algorithm, and carries out encryption in block units each of which includes 16 bytes. The CPU 21 starts the encryption circuit 25, and controls transfer of data to the encryption circuit 25, to externally transmit the encrypted data. The ROM 22 stores information such as a code to operate the CPU 21. The RAM 23 is a memory where data processed when the encryption circuit 25 carries out encryption is expanded if needed. The external interface 24 sends packets encrypted according to TLS to the transmission channel 2.

The communications apparatus 10 includes a CPU 11, a ROM 12, a RAM 13, an external interface (I/F) 14, and a decryption circuit 15 (which is an example of a “description circuit”). Hereinafter, packets according to TLS will be simply referred to as “TLS packets”. For receiving a TLS packet, the CPU 11 executes the code stored in the ROM 112. The external interface 14 (which is an example of a “communications interface”) inputs the TLS packet, transmitted via the transmission channel 2, in the communications apparatus 10. The CPU 11 (which is an example of a “controller”) expands the input TLS packet in the RAM 13, and starts the decryption circuit 15. The decryption circuit 15 reads the TLS packet expanded in the RAM 13, and decrypts the TLS packet according to a procedure that will be described later. The CPU 11 carries out a process depending on a decryption result.

The external interfaces 14 and 24 are communications interfaces that can be connected to various network interfaces such as Ethernet (registered trademark), WiFi (registered trademark), and 3G (Third Generation). It is also possible to input TLS data, transmitted from another apparatus, via an externally connecting interface such as USB, in the communications apparatus 10.

In FIG. 1, for convenience, the communications apparatus 20 (which is an example of a “second communications apparatus”) is illustrated as the transmitter having the encryption function, and the communications apparatus 10 is illustrated as the receiver having the decryption function. However, both the communications apparatus 10 and the communications apparatus 20 may be transmitter-receivers that have transmission/reception functions and encryption/decryption functions.

As will be described later, the communications system 1 can be applied to, for example, a traffic monitoring system. That is, the communications system 1 may be a traffic monitoring system to implement IoT, and the communications apparatus 20 is, for example, a transmitter installed in a traffic light. In this case, a data amount transmitted by one packet is not so large. However, in consideration of a real-time feature of information, there may occur a case where a transmission frequency is high, and a large quantity of short-size packets is transmitted. The communications apparatus 10 at the receiving side is, for example, an on-board terminal, or a portable terminal such as a smart phone that the driver carries. If the communications apparatus 10 receives information, which is desirable to be received in a rear-time manner, cases where the communications apparatus 10 frequently receives data that has been collected in the cloud also increase.

Therefore, the decryption circuit 15 of the communications apparatus 10 carries out decryption and authentication in parallel, assuming that padding attached to a TLS packet has a size (i.e., a padding length) less than or equal to the size of each encrypted unit block. For example, if an AES encryption standard is used, the decryption circuit 15 controls the input of data to an authentication unit assuming that the padding length of a TLS packet is less than or equal to 16 bytes.

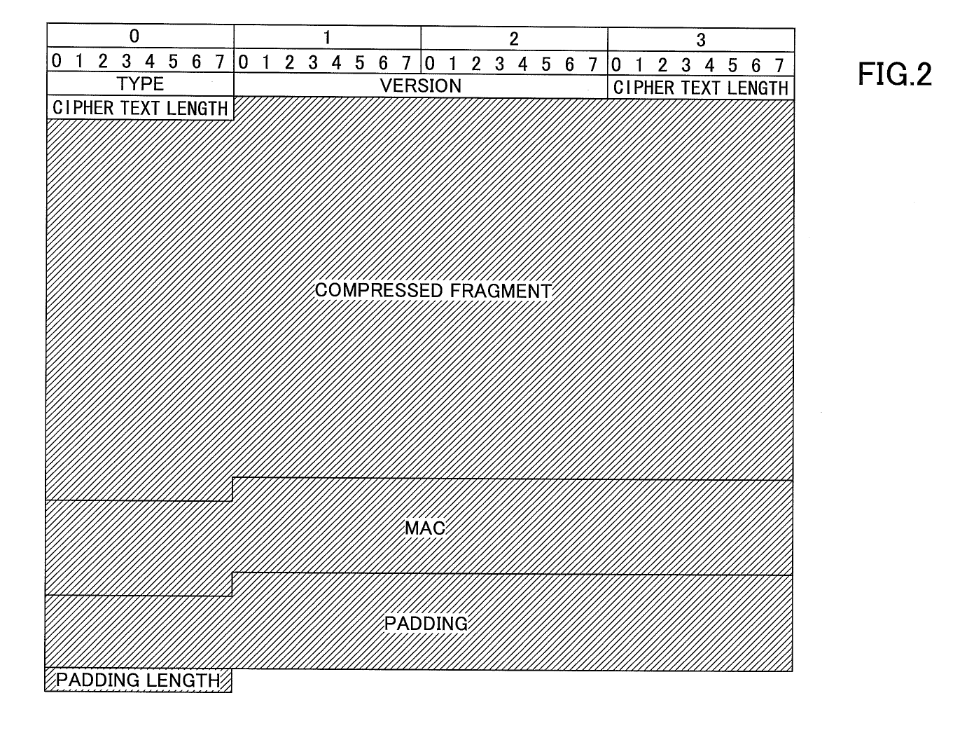

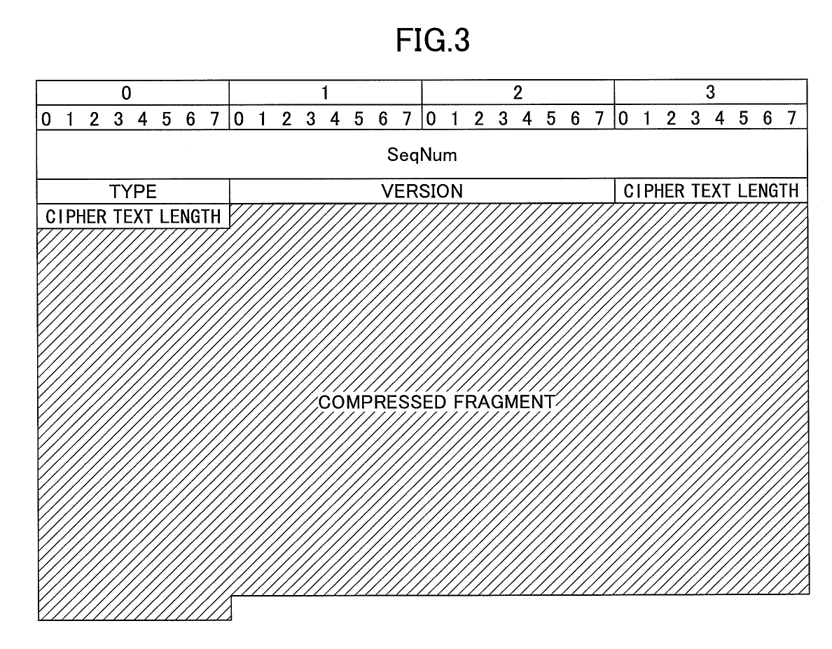

Before describing the decryption circuit and the decryption process in detail, a configuration of a packet used in encryption communications will be described referring to FIGS. 2 and 3.

FIG. 2 illustrates a TLS packet configuration. A TLS packet includes a TLS header of 5 bytes including items “TYPE”, “VERSION”, and “CIPHER TEXT LENGTH”, and respective fields “COMPRESSED FRAGMENT”, “MAC”, “PADDING”, and “PADDING LENGTH”. Among these areas and fields, the fields “COMPRESSED FRAGMENT”, “MAC”, “PADDING”, and “PADDING LENGTH” are encrypted before being transmitted, whereas the TLS header is not encrypted.

The area “TYPE” of the TLS header is used to describe the type of data stored in the payload (i.e., the field “COMPRESSED FRAGMENT”) of the packet. The area “VERSION” is used to describe the version of the corresponding TLS protocol. The area “CIPHER TEXT LENGTH” is used to describe the entire size of the encrypted fields.

The encrypted field “COMPRESSED FRAGMENT” (which is one example of “encrypted data to be used for authentication”) is used to store a message or content. The field “MAC” is used to store a MAC (Message Authentication Code) (i.e., one example of an “authentication code”) value to be used for authentication, as will be described. The field “PADDING” is attached for adjusting a data length concerning the size of an encrypted unit block, as will be described later. The “encrypted unit block” is a data unit in which encryption is carried out. The field “PADDING LENGTH” is a field to store information that indicates the padding length. The contents of the packet can be understood as a result of the respective fields “COMPRESSED FRAGMENT”, “MAC”, “PADDING”, and “PADDING LENGTH” being decrypted.

The field “COMPRESSED FRAGMENT” can have any length up to the upper limit 16 kilobytes (kbytes). However, the entirety of the encrypted fields needs to have a size that is a multiple of the size of an encrypted unit block. In a case of using an AES algorithm, the total size of the encrypted fields is an integral multiple of 16 bytes. Therefore, the padding length is adjusted such that the total of the respective lengths of the fields “COMPRESSED FRAGMENT”, “MAC”, “PADDING”, and “PADDING LENGTH” will be an integral multiple of 16 bytes. Generally speaking, a decryption algorithm uses an immediately preceding decryption result as its input, and carries out decryption in each encrypted unit block in sequence from the beginning.

The size of the field “MAC” depends on an authentication algorithm. If the authentication algorithm is HMAC SHA1, the “MAC” field has 20 bytes. If the authentication algorithm is HMAC SHA256, the “MAC” field has 32 bytes. If the authentication algorithm is HMAC SHA512, the “MAC” field has 64 bytes. The authentication algorithm is defined when a connection is established with a communications partner, before TLS communications is started. Therefore, the size of the field “MAC” is determined at the time a TLS packet is received.

A size of the field “PADDING” is determined in a range between 0 bytes and 255 bytes for adjusting the encrypted fields to an integral multiple of an encrypted unit block. If the total length of the respective fields “COMPRESSED FRAGMENT”, “MAC”, and “PADDING LENGTH” is less than an integral multiple of 16 bytes by, for example, 3 bytes, the padding length may be determined as 3+16k (where k=0 through 15) such as 3 bytes, 19 bytes, 35 bytes, or 51 bytes.

The size of the field “PADDING LENGTH” is fixed as 1 byte, and the padding length is described in the field “PADDING LENGTH”. Because the field size is 1 byte, the padding length is in a range between 0 and 255, and a designatable value as the padding length is in a range between 0 and 255 bytes. When a TLS packet is decrypted, the size of the field “PADDING” is determined from the information described in the field “PADDING LENGTH”. Then, the size of the field “COMPRESSED FRAGMENT” in the packet is determined as a result of a calculation using the size that is known of the field “MAC”.

FIG. 3 illustrates a data portion that is provided to the authentication process when a TLS packet is decrypted. In FIG. 3, the field “COMPRESSED FRAGMENT” is used for authentication. According to TLS authentication, a MAC value is calculated using decryption results of a field “SeqNum”, the TLS header, and the field “COMPRESSED FRAGMENT”. The field “SeqNum” is used to store a sequence number that is previously shared between a transmitting side and a receiving side before transmission and reception of encrypted data. In the authentication process, it is determined whether the calculated MAC value is equal to a decryption result of the MAC value stored in the field “MAC” of the TLS packet. Then, if the calculated MAC value is equal to the MAC value stored in the field “MAC” of the TLS packet, it is determined that the authentication is successful. If the calculated MAC value is not equal to the MAC value stored in the field “MAC” of the TLS packet, it is determined that the authentication has failed.

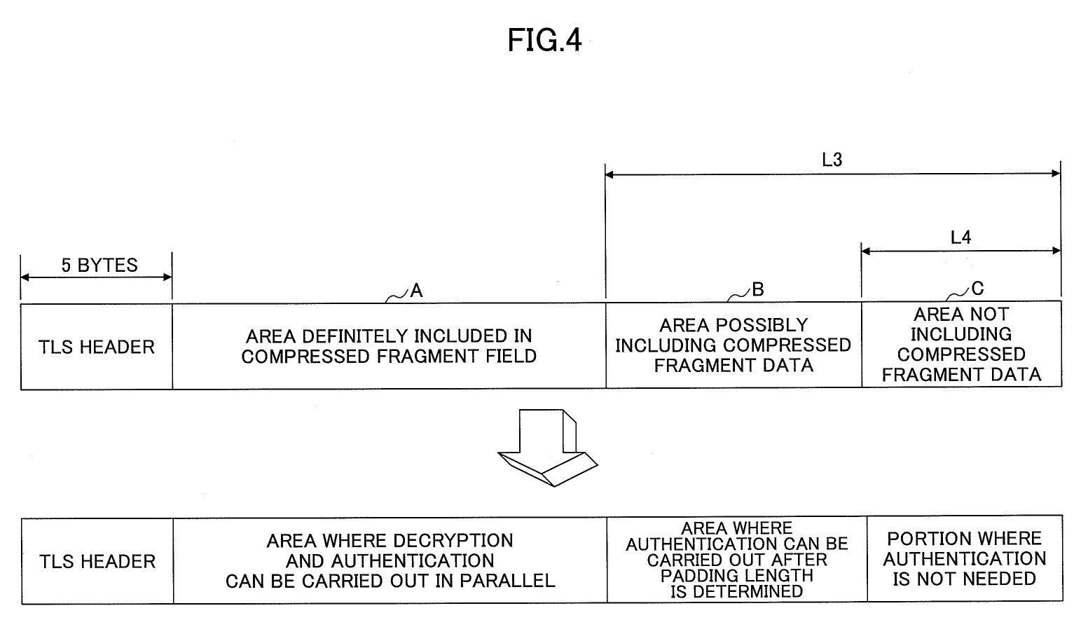

The authentication algorithm uses a decryption result of the field “COMPRESSED FRAGMENT” as its input. Therefore, the decryption result in each encrypted unit block is input to the authentication algorithm in sequence. A TLS packet includes the fields “MAC”, “PADDING”, and “PADDING LENGTH” after the field “COMPRESSED FRAGMENT”, as illustrated in FIG. 2. However, data stored in the fields “MAC”, “PADDING”, and “PADDING LENGTH” is not input to the authentication algorithm in an example that will be described with reference to FIG. 4.

In order to input only decryption results of the field “COMPRESSED FRAGMENT” to the authentication algorithm, there is a need to determine the size of the field “COMPRESSED FRAGMENT”. For this purpose, generally speaking, after the field “PADDING LENGTH” is decrypted, the length of the “COMPRESSED FRAGMENT” is counted backward using the decryption result of the field “PADDING LENGTH”. Authentication and decryption can be carried out in parallel on an area that can be determined as being definitely included in the field “COMPRESSED FRAGMENT” of a TLS packet. However, it may be difficult to carry out authentication and decryption in parallel on an area that may include data stored in the field “MAC” of the TLS packet but cannot not be determined as being definitely included in the field “COMPRESSED FRAGMENT”. This is because it may be difficult to carry out an authentication process on the area that may include data stored in the field “MAC” of the TLS packet, unless the decryption process is completed and the field “COMPRESSED FRAGMENT” is determined. The decryption circuit 15 solves the problem with the method and the configuration that will be described later.

FIG. 4 illustrates a data length that is input to an authentication process in a TLS packet in the above-mentioned example. In the example, when decryption and authentication of a TLS packet will be carried out in parallel, the TLS packet before decryption is divided into an area A (i.e., one example of a “first area”), definitely included in the field “COMPRESSED FRAGMENT”, an area B (i.e., one example of a “second area”) that may possibly include some data stored in the field “COMPRESSED FRAGMENT”, and an area C that does not include any data stored in the field “COMPRESSED FRAGMENT”.

The length of the area A is calculatable using the value indicated by the area “CIPHER TEXT LENGTH” and the size of “MAC” field. The data length of the encrypted portion includes the fields “COMPRESSED FRAGMENT”, “MAC”, “PADDING”, and “PADDING SIZE” (see FIG. 2). The total length of the fields “PADDING” and “PADDING SIZE” is less than or equal to 256 bytes (i.e., 255+1=256). Therefore, the length of the area A is calculated as (CIPHER TEXT LENGTH)−(“MAC” field size)−256.

That is, the data length of the encrypted portion of a TLS packet is stored in the area “CIPHER TEXT LENGTH” of the TLS header, as mentioned above. The padding length (i.e., the size of the field “PADDING”) is in a range between 0 bytes and 255 bytes. The size of the field “PADDING LENGTH” is 1 byte. Therefore, the actual size (i.e., the actual length) of the field “COMPRESSED FRAGMENT” is in a range calculated by the following Formula (1), and the range is determinable from the TLS header.

(CIPHER TEXT LENGTH)−((“MAC” field size)+(“PADDING LENGTH” field size)+255)≦(“COMPRESSED FRAGMENT” field size)≦(CIPHER TEXT LENGTH)−((“MAC” field size)+(“PADDING LENGTH” field size)) Formula (1)

Here, as the code (i.e., the MAC value) stored in the field “MAC”, HMAC (i.e., keyed-Hashing for Message Authentication Code) that includes a combination of a shared key and a hash function is assumed. Therefore, the “MAC” field size may also be called a “HMAC size”.

The lower limit of Formula (1) is a size of the field “COMPRESSED FRAGMENT” when the padding length has the maximum value 255 bytes. The upper limit of Formula (1) is a size of the field “COMPRESSED FRAGMENT” when the padding length has the minimum value 0 bytes.

The area A definitely included in the field “COMPRESSED FRAGMENT” corresponds the lower limit of Formula (1). Therefore, it is possible to carry out decryption and authentication in parallel while decryption results of the area A are input to an authentication process.

An actual padding length is not determinable before the field “PADDING LENGTH” at the end of packet data is decrypted. Before the field “PADDING LENGTH” at the end of packet data is decrypted, it is not possible to determine whether a portion subsequent to the area A in the packet data corresponds to the field “COMPRESSED FRAGMENT”, the field “MAC” or the field “PADDING”. In order to determine whether a portion subsequent to the area A in the packet data corresponds to the field “COMPRESSED FRAGMENT”, the field “MAC”, or the field “PADDING”, there is a need to wait for decryption being carried out up to the end of the packet, and the padding length being determined. Therefore, it is difficult to carry out decryption and authentication in parallel on a portion subsequent to the area A in the packet data.

In the example of FIG. 4, decryption and authentication are carried out in parallel only on the area A definitely included in the field “COMPRESSED FRAGMENT”. In this example, as mentioned above, it is not possible to carry out decryption and authentication in parallel on a portion of the packet data subsequent to the area A. A size L3 of the total of the area B and the area C is calculated by adding 1 byte of the field “PADDING LENGTH” and 255 bytes (the maximum of the padding length) to the size of the field “MAC”. In a case where the authentication algorithm is HMAC SHA256, the size of the field “MAC” is 32 bytes. Therefore, in this example, it is not possible to carry out an authentication process on total 288 bytes (i.e., 32+1+255=288) of data before the padding length is determined. If the size of a TLS packet is as large as, for example, 16 kilobytes, decryption and authentication can be carried out in parallel on almost the entire field “COMPRESSED FRAGMENT”, in the example. However, if the size of a TLS packet is as small as around 256 bytes, there is likelihood that encrypted data does not include the field “COMPRESSED FRAGMENT”. Therefore, the portion, on which decryption and authentication can be carried out in parallel, of the TLS packet, may be very small.

However, according to common TLS protocol implementation such as openSSL, the padding length is set to 16 bytes or less in many cases. If authentication is not carried out on the corresponding portions of the area B, which is not determinable as including data stored in the field “COMPRESSED FRAGMENT” until decryption of the packet is completed even when the actual padding length is 16 bytes or less, at least 239 (i.e., 255-16=239) bytes of data that is actually stored in the field “COMPRESSED FRAGMENT” is not input to an authentication process until the decryption process is completed on the packet that has been encrypted according to openSSL, in the example. In contrast, if the actual padding length is 255 bytes or near 255 bytes, remaining data, if any, to be additionally input to an authentication process after the completion of decryption of the packet is very small.

That is, the configuration according to the example where data is input to an authentication process after the data is determined as definitely included in the field “COMPRESSED FRAGMENT” is advantageous when the packet size is large. However, the configuration in the example rather requires a process time when the configuration is applied to common TLS protocol implementation.

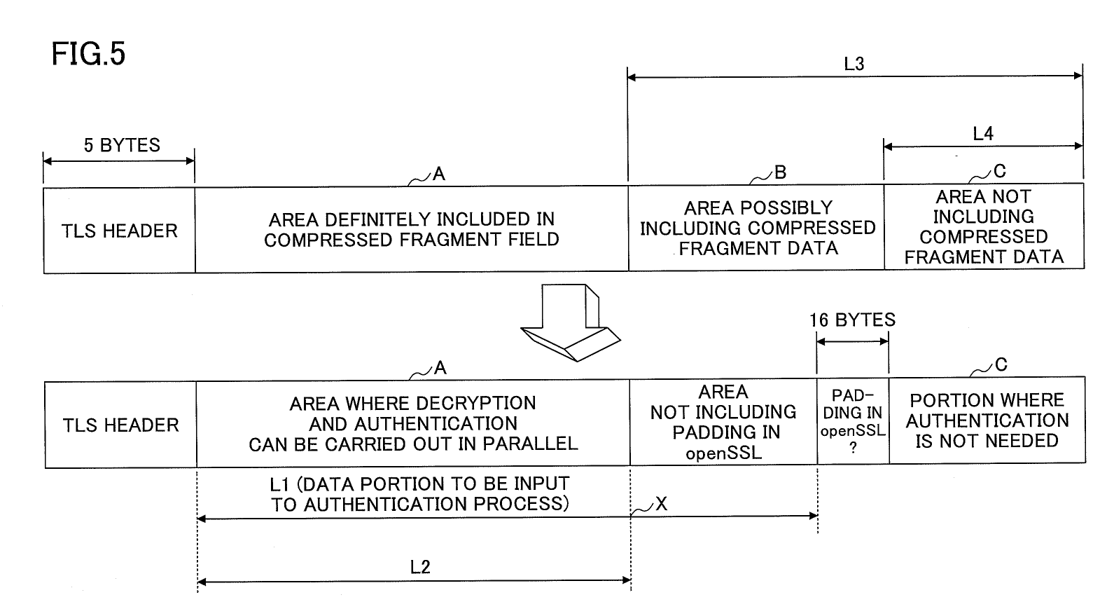

FIG. 5 illustrates a feature of the decryption circuit 15, and illustrates a data length to be input to an authentication process in the decryption circuit 15. The feature of the decryption circuit 15 is to optimize an authentication process to be suitable for the padding length that is generally used in many cases, i.e., 16 bytes or less. By assuming the padding length as 16 bytes or less, it is possible to increase a portion on which an authentication process is carried out before the padding length is determined. In particular, in the decryption circuit 15, an authentication process is optimized in such a manner that a process speed is maximized when common TLS protocol implementation such as openSSL is used.

On the area B, it is not possible to decrypt and authenticate in parallel before the padding length is determined in the above-described example of FIG. 4, although the area B may include data stored in the field “COMPRESSED FRAGMENT”. The area C does not require an authentication process, and has a size L4 calculated by adding 1 byte of the field “PADDING LENGTH” to the size of the field “MAC”. The decryption circuit 15 assumes, at the beginning of decryption of a given TLS packet, that a portion of the encrypted data from the beginning through a position counted backward from the end of the packet by 16 bytes, the size of the field “MAC”, and the size of the field “PADDING LENGTH”, corresponds to the field “COMPRESSED FRAGMENT”, and inputs the portion of the encrypted data assumed to correspond to the field “COMPRESSED FRAGMENT” to an authentication process, to carry out decryption and authentication in parallel on the portion of the encrypted data. A size L1 (i.e., one example of a “first size”) of the portion of the encrypted data to be input to an authentication process is a size calculated by adding 239 bytes to a size L2 of the area A definitely included in the field “COMPRESSED FRAGMENT”. In the decryption circuit 15, decryption and authentication are carried out in parallel on the portion of the size L1 before the padding length is determined. In comparison to the above-described example of FIG. 4, where authentication is carried out on the area B after the padding length is determined, decryption and authentication can be carried out in parallel on the data larger by 239 bytes in the decryption circuit 15.

However, according to the TLS protocol, the padding length may have a value up to 255 bytes. If a packet having the padding length longer than 16 bytes is given, the above-mentioned portion of the size L1 includes data that is not to be input to an authentication process other than the data of the field “COMPRESSED FRAGMENT”. Therefore, it is not possible to properly carry out authentication when the portion of the size L1 is input to the authentication process.

Therefore, an output (which will be referred to as an “intermediate value”, hereinafter) of an authentication process from a position in the area A nearest a boundary X (see FIG. 5) between the area A definitely included in the field “COMPRESSED FRAGMENT” and a subsequent area that may include data stored in the field “COMPRESSED FRAGMENT” is stored in a register. By storing the intermediate value from the position in the area A nearest to the boundary X, an authentication process can be restarted from the position nearest the boundary X if the padding length is longer than 16 bytes. This is because, before the boundary X, all the data that has been input to an authentication process is included in the field “COMPRESSED FRAGMENT”, and thus, the authentication result is valid. Therefore, the intermediate value from the position in the area A nearest to the boundary X can be properly used for the restarted authentication process. As a result, the decryption circuit 15 can process data packets even when the TLS protocols having various padding lengths are used. An actual procedure of restarting an authentication process will be described later.

Note that, in FIG. 5, the area “PADDING IN openSSL?” having 16 bytes represents an area that may include “padding” with high likelihood according to openSSL.

The above-mentioned value “16 bytes” assumes AES as the TLS encryption/decryption algorithm. If another encryption/decryption algorithm is used, the “16 bytes” is replaced by the size of an encrypted unit block according to the algorithm actually used. For example, if DES (Data Encryption Standard), not used after 2015, is used, the padding length is assumed as 8 bytes or less when decryption and authentication are carried out parallel. If an encryption scheme having the size of an encrypted unit block of 32 bytes is used, the padding length is assumed as 32 bytes or less when decryption and authentication are carried out parallel.

According to the example of FIG. 5, the decryption circuit 15 recalculates an authentication result using the decryption results of an area beginning at the position nearest the boundary X of the area A for a packet having the padding length longer than 16 bytes. This way assumes that one data storage area (i.e., one register) is prepared to store the intermediate value. However, it is also possible to prepare a plurality of registers to store intermediate values from a plurality of positions in a portion subsequent to the area A. In this case, the circuit size of the decryption circuit 15 increases as the number of the registers increases. However, this case is advantageous in that, even if a given packet has a padding length slightly exceeding 16 bytes (for example, the padding length is 17 bytes or 18 bytes), the process speed of recalculating the authentication result is increased.

### First Embodiment

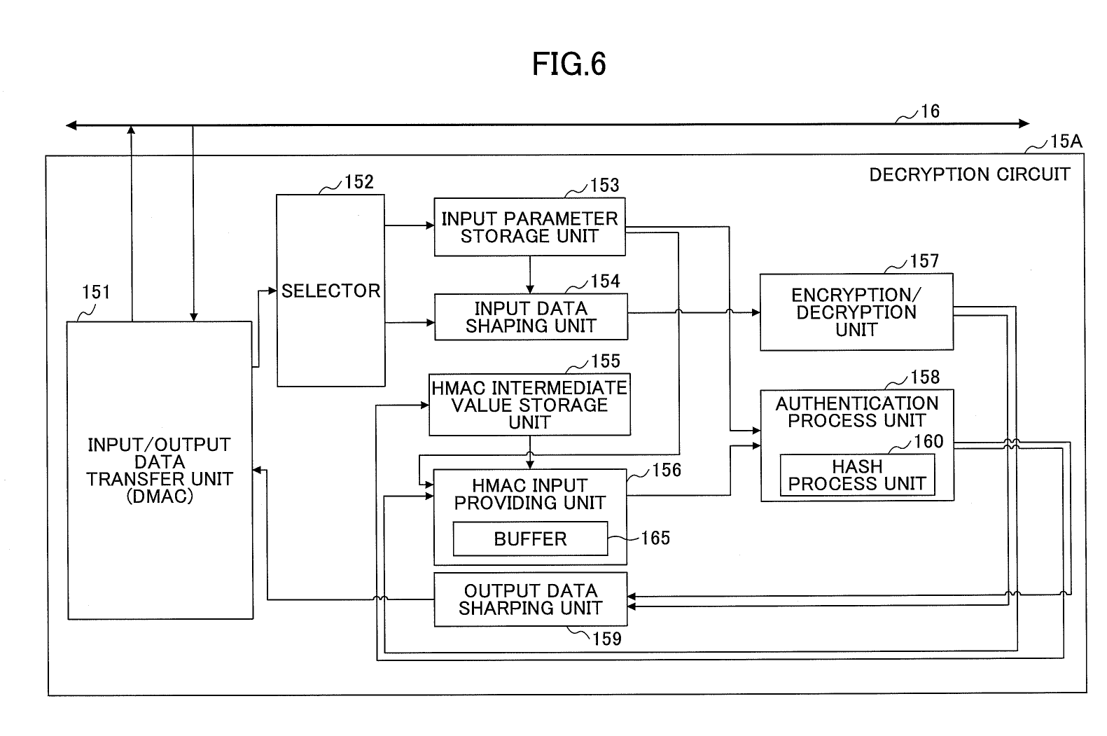

FIG. 6 is a general configuration of a decryption circuit 15A. The decryption circuit 15A is used as the decryption circuit 15 of the communications apparatus 10 in FIG. 1. The decryption circuit 15A includes an input/output data transfer unit 151, a selector 152, an input parameter storage unit 153, an input data shaping unit 154, an authentication intermediate value storage unit 155, an authentication input providing unit 156, an encryption/decryption process unit 157, an authentication process unit 158, and an output data shaping unit 159. The decryption circuit 15A uses a HMAC algorithm for authentication. Therefore, the authentication intermediate value storage unit 155 may be referred to as a “HMAC intermediate value storage unit 155”. In the same way, the authentication input providing unit 156 may be referred to as a “HMAC input providing unit 156”. Below, the element names “HMAC intermediate value storage unit 155” and “HMAC input providing unit 156” will be used actually. Also, the “MAC value” will be referred to as a “HMAC value”, hereinafter.

The input/output data transfer unit 151 receives two data items, i.e., input parameters and input data, from the bus 16. The input parameters include an encryption key used for TLS encryption communications, an initialization vector (IV), the sequence number (SeqNum), the TLS header, an encryption algorithm, and an authentication algorithm. The input data denotes the remaining portion of a TLS packet other than the TLS header. The selector 152 determines whether each data item is to be sent to the input parameter storage unit 153 or the input data shaping unit 154.

The input parameter storage unit 153 stores the input parameters during a TLS decryption process, and provides the input parameters to the HMAC input providing unit 156 and the authentication process unit 158 (which is an example of an “authentication circuitry”). The input data shaping unit 154 receives a body portion of the TLS packet, and sends the data to be decrypted to the encryption/decryption process unit 157.

The encryption/decryption process unit 157 (which is an example of a “decryption circuitry”) decrypts the encrypted data of the TLS packet in each encrypted unit block. The decryption results are sent to the output data shaping unit 159 in sequence, and are then output via the input/output data transfer unit 151 to the bus 16. The decryption results are sent also to the HMAC input providing unit 156, and are input to the authentication algorithm.

The HMAC input providing unit 156 sends the data to be authenticated to the authentication process unit 158 based on information that indicates the encrypted data length (“CIPHER TEXT LENGTH”) included in the input parameters sent from the input parameter storage unit 153, and also based on the HMAC algorithm. As described above, the HMAC input providing unit 156 sends, not only the decryption results of the area A definitely included in the field “COMPRESSED FRAGMENT”, but also the decryption results of a portion, which may include the decryption results of data stored in the field “COMPRESSED FRAGMENT”, subsequent to the area A, to the authentication process unit 158. The authentication process unit 158 carries out the authentication process in parallel with the decryption process (that is carried out by the encryption/decryption process unit 157) on the packet data as much as possible before the padding length is determined. The HMAC input providing unit 156 includes a buffer area 165 (which is an example of a “buffer circuitry”). The HMAC input providing unit 156 buffers the decryption results corresponding to 255 bytes that is the maximum padding length subsequent to the boundary X, prepared for a case where the padding length is longer than 16 bytes. Using the buffered data, recalculation of an authentication result will be carried out if needed.

The authentication process unit 158 carries out an authentication process based on the input data from the HMAC input providing unit 156. At this time, at the boundary X between the area A definitely included in the field “COMPRESSED FRAGMENT” and a subsequent area possibly including data stored in the field “COMPRESSED FRAGMENT”, the intermediate value at the position that is an authentication algorithm data boundary nearest the boundary X in the area A (definitely included in the field “COMPRESSED FRAGMENT”) is temporarily stored in the HMAC intermediate value storage unit 155 (which is an example of an “intermediate value storage circuitry”).

The HMAC intermediate value storage unit 155 stores an authentication result of data of the field “COMPRESSED FRAGMENT” at the position nearest the boundary X of the area A as the intermediate value. If the last decryption result of the TLS packet indicates that the padding length is longer than 16 bytes, the HMAC intermediate value storage unit 155 provides the stored intermediate value to the HMAC input providing unit 156. The HMAC input providing unit 156 sends the received intermediate value (i.e., the authentication result) and the 255 bytes of decryption results buffered as mentioned above to the authentication process unit 158 to recalculate an authentication result.

The output data shaping unit 159 receives the decryption results from the encryption/decryption process unit 157 and the authentication result from the authentication process unit 158. If the HMAC value included in the decryption results is the same as the HMAC value calculated by the authentication process unit 158, the output data shaping unit 159 determines that the authentication is succeeded, and provides the decryption results that are output by the encryption/decryption process unit 157 to the input/output data transfer unit 151. At the end of the decryption results, the decryption results of the field “PADDING” and the field “PADDING LENGTH” are included. The corresponding data may be output together or may not be output. If circuit size miniaturization is given priority, the decryption results of the fields “PADDING” and “PADDING LENGTH” may be sent to the input/output data transfer unit 151, and, then, may be discarded in a software process. If software process reduction is given priority, the output data shaping unit 159 may determine the position of the field “PADDING”, remove the data of the fields “PADDING” and “PADDING LENGTH”, and provide the remaining decryption results to the input/output data transfer unit 151.

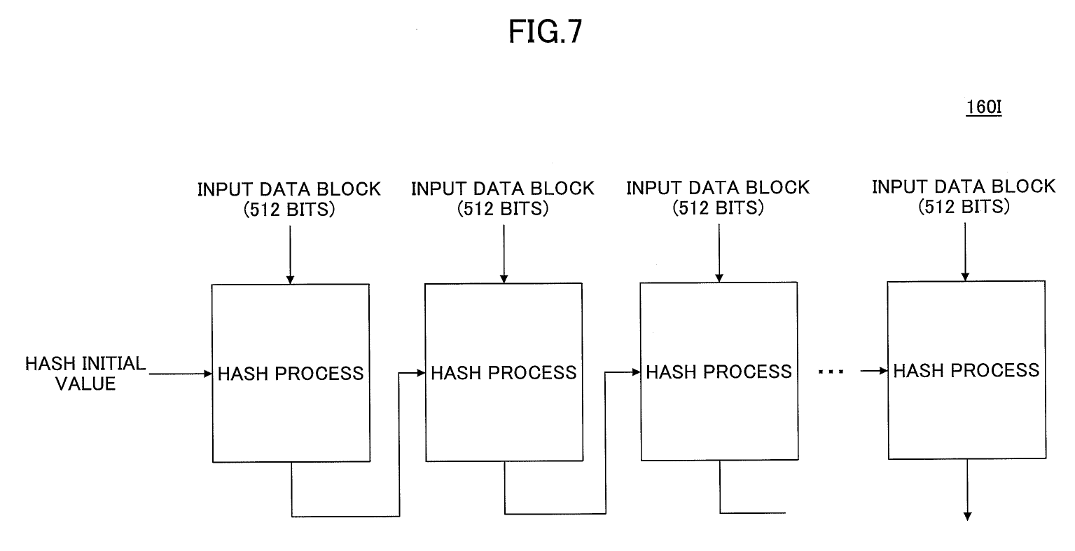

FIG. 7 illustrates a HASH process unit 1601 as one configuration example of the HASH process unit 160 of the authentication process unit 158. The HASH algorithm to carry out an authentication process according to TLS is a process of successively repeating inputting two pieces of data and outputting one piece of data. Data to be input includes an input data block and a previous HASH calculation result. In an initial HASH process, a HASH initial value that is previously determined for each algorithm is used as the previous HASH calculation result. The input data block includes decryption results of data stored in the field “COMPRESSED FRAGMENT” when a decryption process is carried out according to TLS, and is a division having a block length according to the authentication algorithm.

The block length is 512 bits according to SHA1 or SHA256, and is 1024 bits according to SHA512. The example of FIG. 7 assumes SHA1, and therefore, the input data block size is 512 bits. The input data block is provided to the HASH process unit 1601 of the authentication process unit 158 via the HMAC input providing unit 156. The HASH process is repeated until all the input data blocks have been processed, and a value finally acquired from the repetitions of the processes is a HASH output.

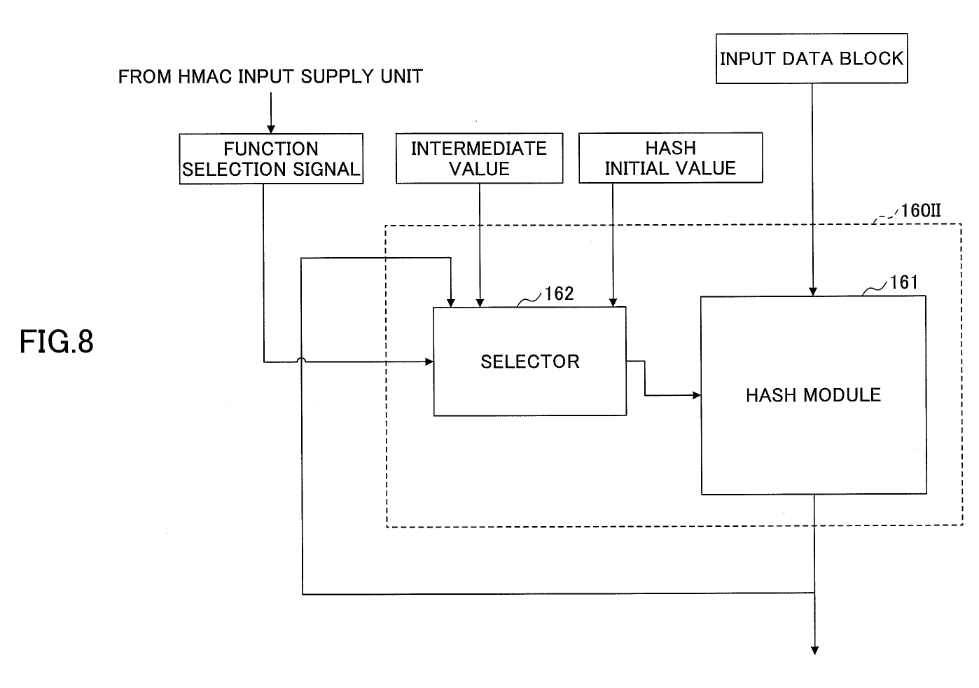

FIG. 8 illustrates a HASH process unit 16011 that is another configuration example of the HASH process unit 160 of the authentication process unit 158. The HASH process unit 16011 of FIG. 8 includes a HASH module 161, and a selector 162 that selects an input to the HASH module 161 (which is an example of an “authentication module circuit”). The selector 162 (which is an example of a “selector”) selects one of the intermediate value and the HASH initial value based on a function selection signal from the HMAC input providing unit 156.

The decryption circuit 15A of FIG. 6 recalculates an authentication result using decryption results of a subsequent area extending from the position nearest the boundary X if the padding length is longer than 16 bytes. In this case, instead of the HASH initial value, the intermediate value of the HASH process carried out on the area A definitely included in the field “COMPRESSED FRAGMENT” is input to the HASH process unit 160, and an authentication result is recalculated from a halfway-point HASH process. For this purpose, in the example of FIG. 8, the selector 162 that selectively outputs the intermediate value of the HASH process and the HASH initial value is used. The selector 162 functions as an interface to input a previous output to the HASH module 161 as a current input. In the configuration of FIG. 8, the HASH process is carried out in sequence using the HASH initial value at the beginning, if the padding length is less than or equal to 16 bytes. If the padding length exceeds 16 bytes, an authentication result is recalculated using the intermediate value that is an output of the HASH module 161 at the position nearest the boundary X of the area A.

The HMAC input providing unit 156 first inputs the function selection signal to the HASH process unit 16011, and starts the HASH module 161. The function selection signal at the time of starting the HASH module 161 is a signal to indicate that the HASH initial value is input to the HASH module 161. Whether the function selection signal that indicates a selection of the intermediate value is to be provided is determined after the HMAC input providing unit 156 receives the decryption results, and determines the padding length. Then, if the padding length is less than or equal to 16 bytes, recalculation of an authentication result is not needed, and therefore, the HMAC input providing unit 156 does not output the function selection signal that indicates a selection of the intermediate value. If the padding length is longer than 16 bytes, the HMAC input providing unit 156 outputs the function selection signal that indicates a selection of the intermediate value. The function selection signal that indicates a selection of the intermediate value data indicates that the process of the HASH module 161 is to be interrupted temporarily, and the data stored in the HMAC intermediate value storage unit 155 is to be input to the HASH module 161.

As a result, an authentication process (i.e., the HASH process) is carried out in sequence assuming that the padding length is less than or equal to the generally used 16 bytes. Then, if the padding length is longer than 16 bytes, recalculation of an authentication result is immediately started using the decryption results of an area extending from the position nearest the boundary X.

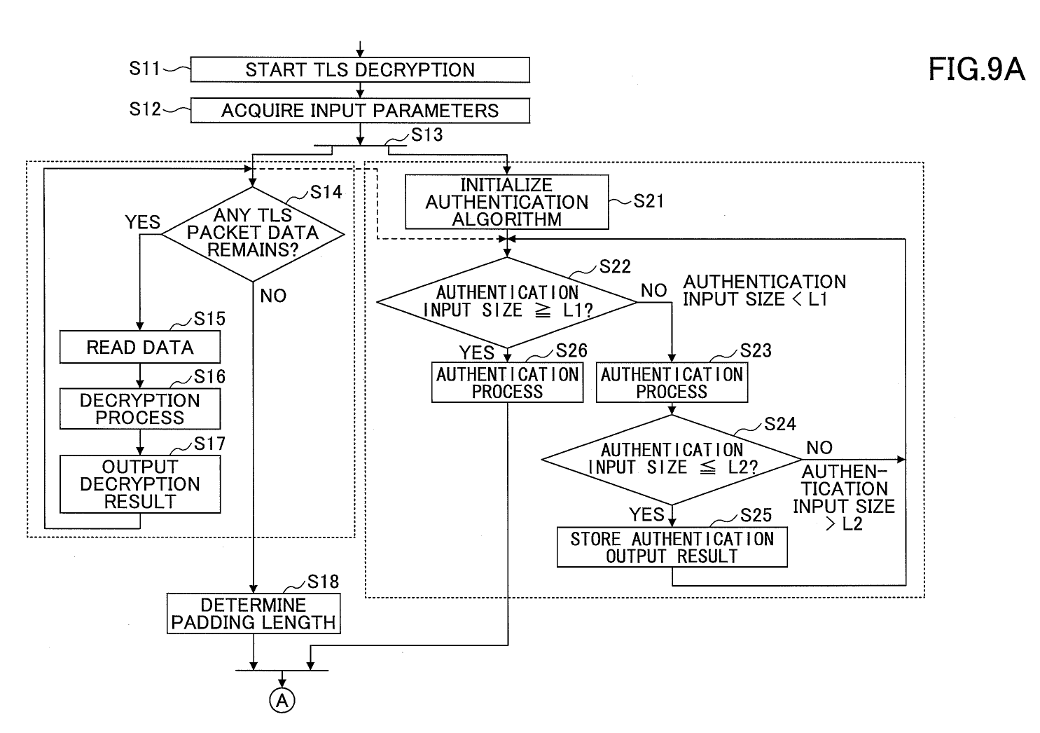

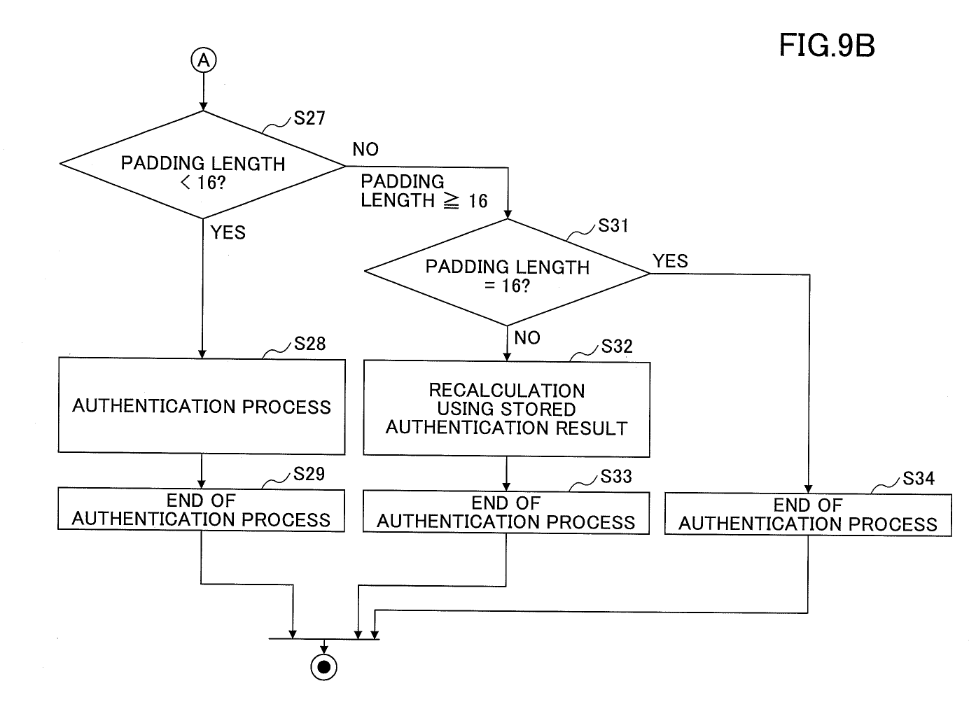

FIGS. 9A and 9B illustrate a process flow of the decryption circuit 15A. First, after the encryption/decryption process unit 157 starts decrypting a TLS packet (step S11), the authentication process unit 158 acquires, from the input parameter storage unit 153, the input parameters (step S12). Then, the encryption/decryption process unit 157 and the authentication process unit 158 carry out the decryption process and the authentication process in parallel (step S13). In FIG. 9A, steps S14-S17 of the decryption process and steps S21-S26 of the authentication process can be carried out in parallel.

The encryption/decryption process unit 157 reads data from the TLS packet as long as the unprocessed data remains in the TLS packet (step S14 through S15), and carries out the decryption process on the read data in each encrypted unit block (step S16). The acquired decryption results are output in sequence (step S17). When all the data of the TLS packet has been decrypted, the padding length is determined (step S18), as mentioned above.

The authentication process unit 158 initializes the authentication algorithm (step S21). The initialization vector (IV) included in the input parameters is used for the initialization. Then, the authentication process unit 158 receives the decryption results in sequence via the HMAC input providing unit 156, and carries out the authentication process using the received decryption results in sequence through repetitions of steps S22-S24. In each of the repetitions of steps S22-S24, the authentication process unit 158 determines whether the input size of the decryption results that have been input for authentication until now amounts to the size L1 or more (step S22).

If the input size of the decryption results for authentication amounts to the size L1 or more (YES in step S22), the authentication process unit 158 proceeds to step S26 to carry out the authentication process using the current input data block of the decryption results, and interrupts the authentication process at this time. This is because, if the padding length is less than or equal to 16 bytes, as assumed, the authentication result acquired at this time can be properly used. In this case, the authentication process unit 158 has consequently carried out the authentication process using the decryption results of the size L1 (i.e., the decryption results of the encrypted data that includes the area A and the subsequent 239 bytes).

If the decryption results are not timely provided to the authentication process unit 158 from the encryption/decryption process unit 157, the authentication process unit 158 waits to receive the decryption results from the encryption/decryption process unit 157. The authentication process unit 158 then waits for the padding length being determined by the encryption/decryption process unit 157 (step S18).

The value of the size L1 is determined in consideration of the padding length less than or equal to 16 bytes according to common implementation such as openSSL. By determining the size L1 in this way, it is possible to reduce, as much as possible, the remaining amount of the decryption results to be processed in the authentication process, if any, after the padding length is determined. That is, it is possible to reduce, as much as possible, the amount of the decryption results on which it is not possible to carry out the authentication process in parallel with the decryption process.

If the input size of the decryption results that have been input for authentication until now amounts a size still less than L1 (NO in step S22), the authentication process unit 158 carries out the authentication process (step S23), and determines whether the input size of the decryption results that have been input for authentication until now amounts to the size L2 of the area A of FIG. 5 (step S24).

If the input size for authentication amounts to a size still less than or equal to L2 (YES in step S24), this situation means that the decryption results that have been acquired until now correspond to encrypted data definitely included in the field “COMPRESSED FRAGMENT” of the TSL packet. In step S24, if the input size of the decryption results that have been input for authentication until now amounts to a size nearest L2, the authentication process unit 158 stores the current authentication result as the intermediate value in the HMAC intermediate value storage unit 155 (step S25). Then, the authentication process unit 158 returns to step S22 to repeat steps S22-S24.

If the input size of the decryption results that have been input for authentication until now then amounts to a size larger than L2 (NO in step S24), the authentication process unit 158 returns to step S22 to repeat steps S22-S24. The authentication process unit 158 then continues the repetitions of steps S22-S24 until the determination result of step S22 becomes YES. After the determination result of step S22 becomes YES, the authentication process unit 158 carries out step S26, and interrupts the authentication process, as mentioned above.

However, if the input size of the decryption results that have been input for authentication until now is still less than the size nearest L2 in step S24, the authentication process unit 158 returns to step S22 to repeat steps S22-S24 until the input size of the decryption results that have been input for authentication until now amounts to the size nearest L2 as mentioned above.

The process of FIG. 9B is started after the decryption process in FIG. 9A is completed because the process of FIG. 9B uses the padding length that is determined in step S18 after the completion of the decryption process.

In FIG. 9B, using the padding length determined in step S18, a final process of authentication is carried out. That is, the authentication process unit 158 determines whether the determined padding length is less than 16 bytes (step S27). If the padding length is less than 16 bytes (YES in step S27), the authentication process unit 158 carries out the authentication process using the decryption result (corresponding to the encrypted data less than 16 bytes) of the field “COMPRESSED FRAGMENT” acquired after the input size of the decryption results that have been input for authentication exceeds the size L1 (step S28). Thus, the authentication process is completed (step S29).

If the padding length is longer than or equal to 16 bytes (NO in step S27), the authentication process unit 158 determines whether the determined padding length is equal to 16 bytes (step S31). If the padding length is longer than 16 bytes (NO in step S31), this situation means that the size of the field “COMPRESSED FRAGMENT” has a size less than L1, and therefore, the authentication result acquired in step S26 in FIG. 9A is not valid. Therefore the authentication process unit 158 uses the intermediate value (i.e., the authentication result) stored in step S25 and the decryption results buffered in the buffer area 165 of the HMAC input providing unit 156 to recalculate the authentication result (step S32). Thus, the authentication process is completed (step S33).

If the padding length exceeds 16 bytes (NO in step S31), the input size for the recalculation in step S32 is less than 239 bytes (the remainder of subtracting the padding length from the area B). In consideration of a fact that the padding length that is used commonly is short as mentioned above, the input size for the recalculation in this case may be close to 239 bytes in many cases. In such a case, for a TLS packet having the padding length exceeding 16 bytes, the overall process speed of the decryption process and the authentication process may be equivalent to the overall process speed of the decryption process and the authentication process in the example described above with reference to FIG. 4.

If the padding length is equal to 16 bytes (YES in step S31), this situation means that the field “COMPRESSED FRAGMENT” has the size L1. Therefore, the authentication result of step S26 is the final authentication result. Thus, the authentication process is completed (step S34).

According to the decryption circuit 15A described above, the process speed is optimized for TSL packets having the padding lengths less than or equal to 16 bytes that are in conformity with openSSL implementation. In the method described above with reference to FIG. 4, the authentication process stops for data occurring subsequent to the area A. In contrast, in the decryption circuit 15A, the decryption process and the authentication process are carried out in parallel on the decryption results corresponding to the encrypted data of the area A and further 239 bytes counted from the end of the area A according to the corresponding assumption of the padding length. Therefore, the process speed improves as a whole according to the decryption circuit 15.

### Second Embodiment

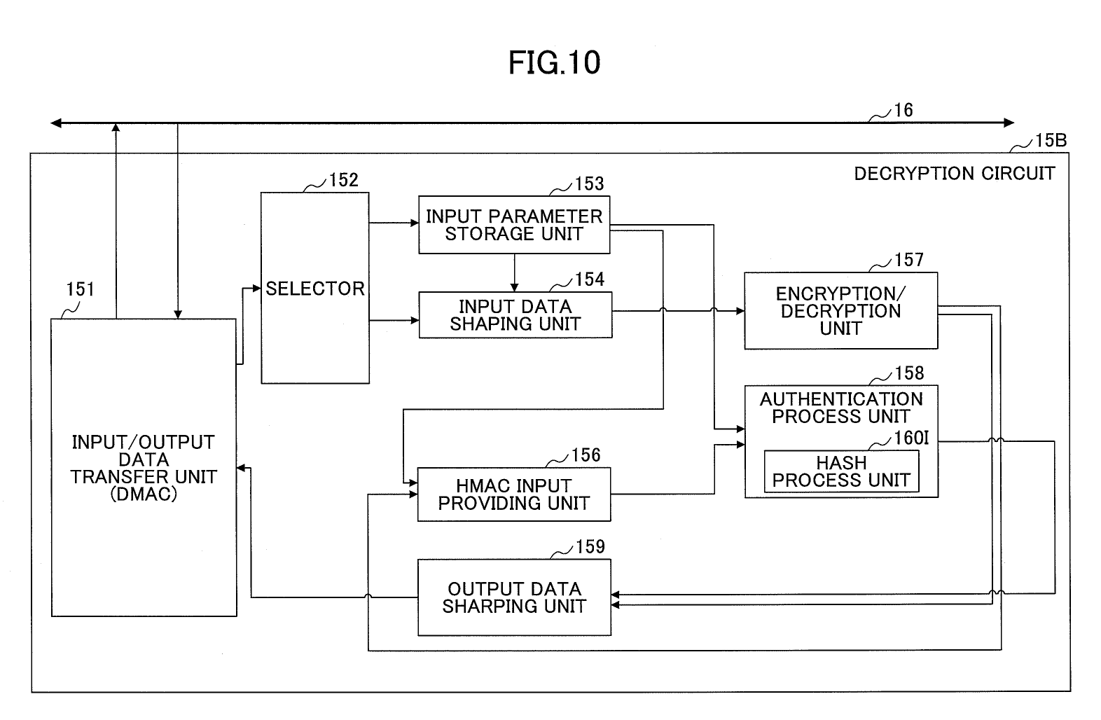

FIG. 10 is a general configuration diagram of a decryption circuit 15B according to a second embodiment. The decryption circuit 15B assumes that packets that are transmitted and received in the communications system 1 are limited to packets each having the padding length less than or equal to the size of an encrypted unit block. Thereby, storing the intermediate values of the authentication algorithm is omitted. In a case in conformity with the AES standard, the communications system 1 of FIG. 1 transmits and receives only TLS packets having the padding lengths less than or equal to 16 bytes.

The decryption circuit 15B differs from the decryption circuit 15A of FIG. 6 in that the HMAC intermediate value storage unit 155 is omitted. Thereby, the circuit configuration is simplified. Also, the HMAC input providing unit 256 need not have the buffer area 165 of 255 bytes for recalculation. Further, because the circuit for recalculation of an authentication result is not needed, the authentication process unit 158 has the HASH process unit 1601 of FIG. 7 having a simple configuration.

This configuration is advantageous when the communications system 1 of FIG. 1 is used for such a purpose as a traffic monitoring purpose in that data transmission and reception are carried out with packets having small sizes.

### Application Example

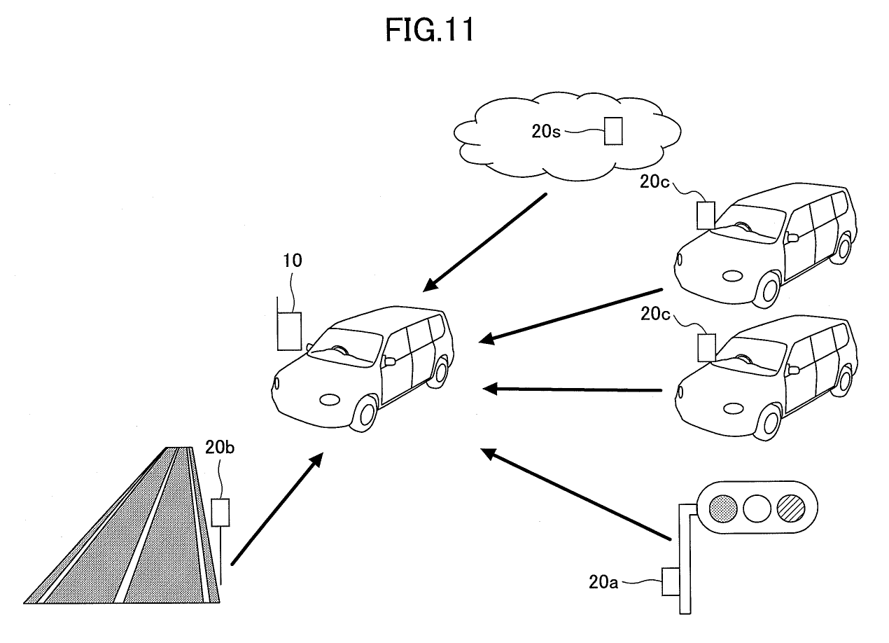

FIG. 11 illustrates an example the application of the communications system 1. The decryption circuit 15A or the decryption circuit 15B is further advantageous if required performance of the communications apparatus 10 at the receiving side is limited, and a plurality of the communications apparatuses 20 at the transmitting side are used. A vehicle communications system will now be described as one example that meets the conditions.

Communications of automobiles in consideration of new technology such as automatic driving technology may be expected to be carried out in various ways. The communications apparatus 10 acquires the latest traffic information from, for example, a cloud server 20s, and also, receives vehicle information from the communications apparatuses 20c of vehicles traveling nearby. Also, the communications apparatus 10 acquires traffic light information, such as information that indicates timing when traffic lights are switched from red to green, and acquires latest traffic conditions from communications apparatuses 20b installed at roadside.

Concerning mobile objects such as vehicles that move at high speeds, a delay in information is desired to be avoided. In order to avoid a traffic accident, there is a need for rapidly determining how a vehicle is to operate, using information acquired through communications. Therefore, it is desired to avoid a CPU installed in a vehicle from being occupied by a communications process, and a communications process is desired to be implemented by hardware, and is desired to be offloaded from the CPU. From this viewpoint, the decryption circuit 15A and the decryption circuit 15B are advantageous.

In a situation illustrated in FIG. 11, an improvement in the process speed of the decryption circuit 15A or 15B is also advantages. Because a plurality of communications apparatuses 20 transmit data simultaneously, the received data is desired to be immediately decrypted and provided to a subsequent process. Therefore, an improvement in the process speed of the decryption circuit 15A or 15B is very important requirement. From the viewpoint of a requirement to update firmware that controls equipment installed in a vehicle, for example, it is desirable that the communications apparatus 10 consumes less power so that the communications apparatus 10 may be driven by a battery. From this viewpoint, it is also desirable to reduce the operation clock frequency as much as possible.

In the decryption circuit 15A or 15B, as described above, data that can be decrypted and authenticated in parallel is made larger by 239 bytes. As a result, it is possible to reduce the process time by approximately five times of the HASH process. In other words, it is possible to reduce the period of time needed for the HASH calculation by approximately 64 bytes every time of HASH process. The HASH process is an iteration process of repeating a certain process 80 times. Therefore, at least a time of 80 clock pulses is required every time of HASH process. As a result, the advantageous effect of the improvement in the process speed in the decryption circuit 15A or 15B amounts to 400 clock pulses.

Assuming that the decryption circuit 15A or 15B is operated at 8 kHz from the viewpoint of the requirement to reduce the operation clock frequency as much as possible, the difference of the 400 clock pulses corresponds to 0.05 seconds. Assuming that six of the communications apparatuses 20 with which the communications apparatus 10 carries out communications are included in the system, it is possible to reduce the process time by 0.3 seconds. In highway traveling, a vehicle moves approximately 10 m per 0.3 seconds. Therefore, the reduction in the process time by 0.3 seconds may avoid a traffic accident.

In the decryption circuits 15A and 15B, a range where decryption and authentication can be carried out in parallel is increased, and a decryption process and an authentication process can be carried out at high speed for packets of any size. Thus, it is advantageous to apply the decryption circuit 15A or 15B to various communications systems which need high speed processes.

Thus, the decryption circuits, communications apparatuses, and communications systems have been described in the embodiments. However, embodiments are not limited to the above-described embodiments, and various modifications and replacements may be made.

What is claimed is:

1. A decryption circuit comprising:
a decryption circuitry configured to decrypt encrypted data in each encrypted unit block to acquire a decryption result; and
an authentication circuitry configured to authenticate the encrypted data, using the decryption results, in parallel with decrypting the encrypted data in each encrypted unit block by the decryption circuitry until the decryption results amount to a first size of the encrypted data,
wherein the encrypted data has a first area and a second area, the first area and the second area are added to calculate the first size of the encrypted data, and wherein the first area of the encrypted data is definitely included in a field of the encrypted data to be used for authentication, and the second area of the encrypted data possibly includes data of the field of the encrypted data to be used for authentication.

2. The decryption circuit according to claim 1,
wherein a size of a field that indicates a padding length, a size of a field that indicates an authentication code, and a size of each encrypted unit block are subtracted from an entire size of the encrypted data to calculate the first size.

3. The decryption circuit according to claim 2,
wherein the authentication circuitry is further configured to authenticate the encrypted data using the decryption results corresponding to a remainder of the field of the encrypted data to be used for authentication left after using the first size of the encrypted data for authentication after decrypting the entire size of the encrypted data by the decryption circuitry, if decryption of the field that indicates the padding length by the decryption circuitry indicates that the padding length is less than the size of each encrypted unit block.

4. The decryption circuit according to claim 2, further comprising
an intermediate value storage circuitry configured to store an authentication result as an intermediate value until the decryption results amount to a second size,
wherein the size of the field that indicates the padding length, the size of the field that indicates the authentication code, and the maximum padding length are subtracted from the entire size of the encrypted data to calculate the second size.

5. The decryption circuit according to claim 4,
wherein the authentication circuitry is further configured to authenticate the encrypted data using the intermediate value after decrypting the entire size of the encrypted data by the decryption circuitry, if decryption of the field that indicates the padding length by the decryption circuitry indicates that the padding length is longer than or equal to the size of each encrypted unit block.

6. The decryption circuit according to claim 4,
wherein the authentication circuitry is further configured to include:
a selector configured to select one of the intermediate value and an initial value for authentication; and
an authentication module circuit configured to authenticate the encrypted data using the value selected by the selector.

7. The decryption circuit according to claim 4, further comprising
a buffer circuitry configured to buffer the decryption results corresponding to an end of the first size of the encrypted data for the maximum padding length,
wherein the authentication circuitry is further configured to authenticate the encrypted data using the intermediate value and the data buffered by the buffer circuitry after decrypting the entire size of the encrypted data by the decryption circuitry, if decryption of the field that indicates the padding length by the decryption circuitry indicate that the padding length is longer than the size of each encrypted unit block.

8. The decryption circuit according to claim 1,
wherein the decryption circuitry is further configured to receive only the encrypted data having the padding length less than or equal to the size of each encrypted unit block.

9. The decryption circuit according to claim 4,
wherein the maximum padding length is 255 bytes.

10. The decryption circuit according to claim 1,
wherein the size of each encrypted unit block is 16 bytes.

11. A communications apparatus comprising:
the decryption circuit claimed in claim 1;
a communications interface; and
a controller configured to start the decryption circuit in response to reception of the encrypted data via the communications interface.

12. A communications system comprising:
the communications apparatus claimed in claim 11; and
a second communications apparatus that transmits the encrypted data.
